(19) United States
(12) Patent Application Publication
(10) Pub. No.: US 2005/0226727 A1
(43) Pub. Date: Oct. 13, 2005

(54) Methods and systems for controlling the pitch of a propeller

(76) Inventors: Brian D. Dennis, White Salmon, WA (US); Kenneth Hillen, Aloha, OR (US)

Correspondence Address: PERKINS COIE LLP;PATENT-SEA, P.O. BOX 1247, SEATTLE, WA, 98111-1247, US

(21) Appl. No.: 11/071,890

(22) Filed: Mar. 2, 2005

Related U.S. Application Data
(60) Provisional application No. 60/549,684, filed on Mar. 3, 2004.

(51) Int. Cl. F03D 1/00

(52) U.S. Cl. 416/98

(57) ABSTRACT

Apparatuses and methods for controlling the motion of a propeller blade are disclosed. In one embodiment, the apparatus can include a first motor that rotates a propeller about a first axis with a first shaft. A first signal transmission portion, fixed relative to the first motor, can transmit signals to a second signal transmission portion that rotates with the first shaft. A second motor can be carried by the first shaft and can receive signals from the second signal transmission portion. The second motor can drive blades of the propeller about a second axis generally transverse to the first axis via a second shaft to vary the pitch of the blades.

### CROSS REFERENCE TO RELATED APPLICATION

The present application claims priority to U.S. Provisional Application 60/549,684, filed Mar. 3, 2004 and incorporated herein by reference.

### TECHNICAL FIELD

The present invention relates generally to methods and systems for controlling the pitch of a propeller, for example, a propeller used to power an unmanned air vehicle.

### BACKGROUND

Variable pitch mechanisms are typically employed on propeller- or rotor-driven fixed wing aircraft and helicopters to improve the performance of these vehicles. Variable pitch mechanisms adjust the angle of attack of the blades to control the direction and magnitude of the forces generated by the blades as they spin. For example, such mechanisms are used on fixed wing aircraft to optimize the pitch of the blades at a variety of air speeds, and to provide for thrust reversing. Such mechanisms are used on helicopters to control the lift generated by the spinning blades.

One existing arrangement for varying the pitch of spinning propeller blades includes a “swash plate” mechanism. This mechanism includes a linear actuator arranged generally parallel to the propeller drive shaft, and a swash plate that rotates with the propeller. The actuator pushes on the swash plate via a thrust bearing to rotate the propeller blades relative to each other about axes that are transverse to the drive shaft. Another existing arrangement includes a hydraulically actuated variable pitch mechanism. Both foregoing arrangements suffer from several drawbacks. For example, both arrangements can be relatively heavy and can have significant internal frictional losses, which together reduce the performance of the aircraft upon which they are installed. Furthermore, hydraulic systems may be susceptible to fluid leakage.

### SUMMARY

The following summary is provided for the benefit of the reader only, and does not limit the invention as set forth by the claims. A propeller system in accordance with one aspect of the invention includes a propeller having a first blade portion and a second blade portion, with the first and second blade portions being rotatable together about a first axis and being rotatable relative to each other about a second axis generally transverse to the first axis. A shaft can be coupled to the propeller to rotate the propeller about the first axis. The system can further include a first signal transmission portion and a second signal transmission portion that is coupled to the shaft to receive signals from the first signal transmission portion as the shaft rotates. The system can still further include an actuator carried by the shaft and coupled to the second signal transmission portion to receive the signals. The actuator can be coupled to the first and second blade portions to rotate the first and second blade portions about the second axis.

In further particular aspects of the invention, the first and second transmission portions can be configured to transmit signals via an electromechanical link. For example, the first and second signal transmission portions can include portions of a rotary transformer. In other embodiments, the first and second signal transmission portions can include a slip ring arrangement configured to transmit electrical signals to the actuator.

The invention is also directed toward methods for controlling the pitch of aircraft propeller blades. A method in accordance with one aspect of the invention includes transmitting an electromagnetic signal to an actuator carried by a rotating propeller shaft. The method can further include activating the actuator via the electromagnetic signal so as to change the pitch angle of propeller blades carried by the rotating propeller shaft. In a further particular aspect, the method can include receiving eccentric pins carried by the propeller blades in slots of a nut. The method can still further include rotating the propeller blades in opposite directions about a pitch axis by rotating a leadscrew about a leadscrew axis with the leadscrew being engaged by the nut, and translating the nut along the leadscrew axis.

### BRIEF DESCRIPTION OF THE DRAWINGS

FIG. 1 is a partially schematic, partially cutaway isometric illustration of an arrangement for varying the pitch of propeller blades in accordance with an embodiment of the invention.

FIG. 2A is a partially schematic, isometric illustration of an arrangement for varying the pitch of a propeller with a leadscrew in accordance with another embodiment of the invention.

FIG. 2B is a partially cut-away illustration of the arrangement shown in FIG. 2A.

FIGS. 3A-3E are partially schematic, isometric illustrations of arrangements for varying the pitch of a propeller blade in accordance with yet further embodiments of the invention.

FIG. 4 is a block diagram illustrating a system for varying the pitch of propeller blades in accordance with still another embodiment of the invention.

FIG. 5 is a schematic illustration of an arrangement for providing bi-directional pitch variation for propeller blades in accordance with yet another embodiment of the invention.

FIG. 6 is a partially schematic illustration of an aircraft on which a variable pitch system can be installed in an embodiment of the invention.

FIGS. 7A-7E are partially schematic illustrations of aircraft on which variable pitch systems can be installed in accordance with other embodiments of the invention.

### DETAILED DESCRIPTION

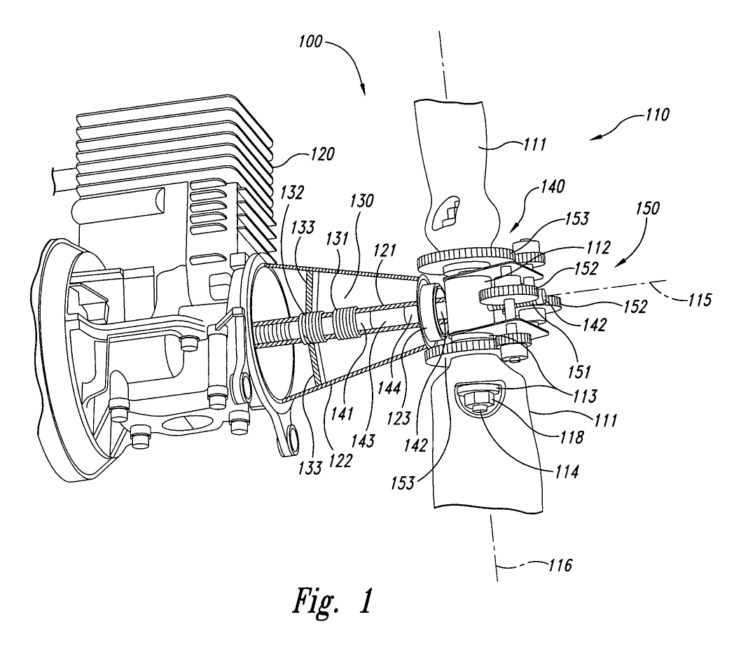

The following disclosure describes systems and methods for controlling propellers or other rotating airfoils, for example, controlling the pitch of a propeller on an aircraft. Certain specific details are set forth in the following description and in FIGS. 1-7E to provide a thorough understanding of various embodiments of the invention. Well-known structures, systems and methods often associated with variable pitch mechanisms have not been shown or described in detail below to avoid unnecessarily obscuring the description of the various embodiments of the invention. In addition, those of ordinary skill in the relevant art will understand that additional embodiments of the present invention may be practiced without several of the details described below.

FIG. 1 is a partially schematic, partially broken-away isometric illustration of a propulsion system 100 configured in accordance with an embodiment of the invention. In one aspect of this embodiment, the propulsion system 100 includes a first or primary motor 120 (e.g., a propulsion motor) coupled with a first or primary shaft 121 to a propeller 110. The first motor 120 can include a reciprocating engine (as shown in FIG. 1) or another device, such as a turbine engine, electric engine or rotary engine. The propeller 110 can include one or more blades or blade portions 111 (two are shown in FIG. 1), each of which is coupled to a common blade head 112. In one aspect of this embodiment, each blade 111 is coupled to the blade head 112 with a threaded stud 114 and a nut 118. Thrust washers 113 carry centrifugal loads generated by the blades 111 as the propeller 110 rotates. The blade head 112 is coupled to the first shaft 121 to transmit rotational motion generated by the first motor 120 to the propeller 110. The first shaft 121 can be coupled to a radial bearing 123 having an inner race fixed to the first shaft 121, and an outer race coupled to a bearing support 122 disposed around the first shaft 121. Accordingly, the bearing support 122 and the bearing 123 support the first shaft 121 and the propeller 110 as the first shaft 121 and the propeller 110 rotate about a first axis 115.

The propulsion system 100 can further include a variable pitch device 140 that rotates each blade 111 in opposite directions about a second axis 116 arranged generally transverse to the first axis 115. In one aspect of this embodiment, the variable pitch device 140 includes a second (variable pitch) motor 143 housed within the first shaft 121 to rotate with the first shaft 121. The variable pitch motor 143 is coupled to a second shaft 142 that extends coaxially through the first shaft 121 and through the blade head 112 to a gearhead 144 and a coupling 150. The coupling 150 and the roots of the blades 111 can be housed in a spinner (not shown in FIG. 1). The coupling 150 operatively couples the second shaft 142 to the blades 111. Accordingly, the variable pitch motor 143, the second shaft 142, the coupling 150, and the propeller 110 can rotate as a unit when the first shaft 121 rotates. The variable pitch motor 143 can also rotate the second shaft 142 relative to the first shaft 121 to control the pitch of the blades 111, as described in greater detail below.

In one aspect of an embodiment shown in FIG. 1, the coupling 150 includes a worm 151 engaged with two worm gears 152, each of which rotates in opposite directions as the worm 151 rotates about the first axis 115. The worm gears 152 are each coupled to a train of spur gears 153 which are in turn coupled to the blades 111. Accordingly, as the worm 151 rotates relative to the first shaft 121 about the first axis 115, each blade 111 rotates in opposite directions about the second axis 116 to change the pitch angle of the blades 111.

In another aspect of an embodiment shown in FIG. 1, the variable pitch motor 143 receives power from a signal transmission link 130. In a particular aspect of this embodiment, the signal transmission link 130 can include a rotary transformer that transmits electrical signals (e.g., electrical power) to the rotating variable pitch motor 143 housed in the rotating first shaft 121. Accordingly, the signal transmission link 130 can include a fixed portion 132 (that is fixed relative to the primary motor 120) and a rotary portion 131 (that is fixed relative to the first shaft 121, but rotates relative to the primary motor 120). The fixed portion 132 can be coupled to brackets 133, which are in turn carried by the bearing support 122. Accordingly, the fixed portion 132 does not rotate with the first shaft 121. When electrical power is applied to the fixed portion 132, it creates an electromagnetic field, in which the rotary portion 131 rotates. Accordingly, electrical signals are transmitted from the fixed portion 132 to the rotary portion 131 both while the first shaft 121 rotates and while the first shaft 121 is stationary (for example, when the primary motor 120 is not running), without direct mechanical contact between the two portions. In other embodiments, the signal transmission link 130 can include other arrangements for transmitting electrical signals to the rotating variable pitch motor 143, for example, a brush and rotor arrangement or a split ring arrangement.

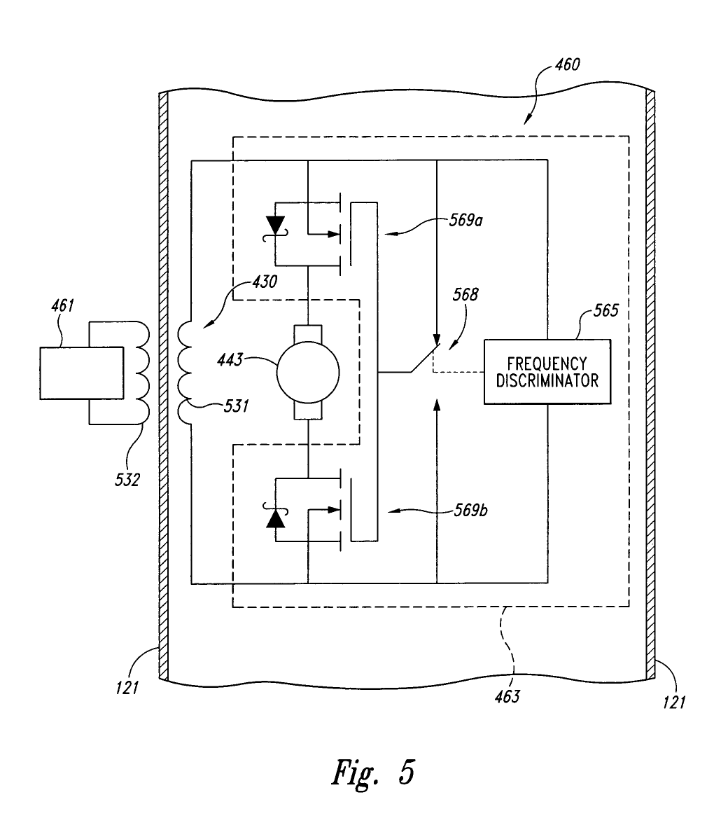

The variable pitch motor 143 can receive power from the rotary portion 131. Optional motor circuitry 141 coupled between the rotary portion 131 and the variable pitch motor 143 can condition or otherwise modify the electrical signals provided by the signal transmission link 130 before they are delivered to the variable pitch motor 143. For example, when the signals transmitted by the signal transmission link 130 are AC signals, the motor circuitry 141 can modulate the signals. If the variable pitch motor 143 is a DC motor, the motor circuitry 141 can rectify the incoming AC electrical signal to make it suitable for powering the DC variable pitch motor 143. In either embodiment, the variable pitch motor 143 can receive electrical power via the signal transmission link 130 to rotate the variable pitch shaft 142 and accordingly adjust the pitch of the blades 111. Further aspects of the motor circuitry 141 are described below with reference to FIG. 5.

One feature of an embodiment of the propulsion system 100 described above with reference to FIG. 1 is that the variable pitch motor 143 is relatively small in size and is housed within the first shaft 121. An advantage of this arrangement is that the weight of the variable pitch motor 143 can be relatively low, which reduces the weight impact of adding a variable pitch capability to the propulsion system 100. This feature can be particularly useful when installing the variable pitch device on a lightweight aircraft, for example, a relatively small unmanned air vehicle (UAV). Another advantage of this arrangement is that the variable pitch motor 143 does not extend a significant distance radially outwardly from the first rotation axis 115. Accordingly, the variable pitch motor 143 can have a small and/or negligible effect on the force required to rotate and/or stop the first shaft 121 and the propeller 110. Yet another advantage of the foregoing arrangement is that, because the variable pitch motor 143 is carried by the rotating primary shaft 121, it is unnecessary to transmit forces or torques (aside from electromagnetic forces) across a rotating boundary. Accordingly, the frictional losses typically associated with such a force or torque transfer are avoided, improving the efficiency of the system 100.

Another feature of an embodiment of the system 100 shown in FIG. 1 is that the propeller 110 is positioned between the coupling 150 and the first motor 120. Accordingly, the propeller 110 can be positioned relatively close to the first motor 120, without requiring space between the propeller 110 and the first motor 120 to accommodate the coupling 150. An advantage of this arrangement is that the length of the first shaft 121 can be relatively short, despite the addition of the variable pitch mechanism 140. As a result, the bending moments on the first shaft 121, though they may be increased slightly by the presence of the coupling 150, will not be increased by positioning the propeller 110 further away from the first motor 120.

Still another feature of an embodiment of the system 100 shown in FIG. 1 is that the fixed portion 132 and the rotary portion 131 of the signal transmission link 130 are not in mechanical contact with each other as they move relative to each other. Accordingly, these components are less likely to wear out as a result of friction than are components that are in mechanical contact with each other. This arrangement can also provide electrical (and electrical noise) isolation between the fixed portion 132 and the rotary portion 131. When the signal transmission link 130 includes a rotary transformer, this arrangement can also be used to step up or step down the voltage of the transmitted signal.

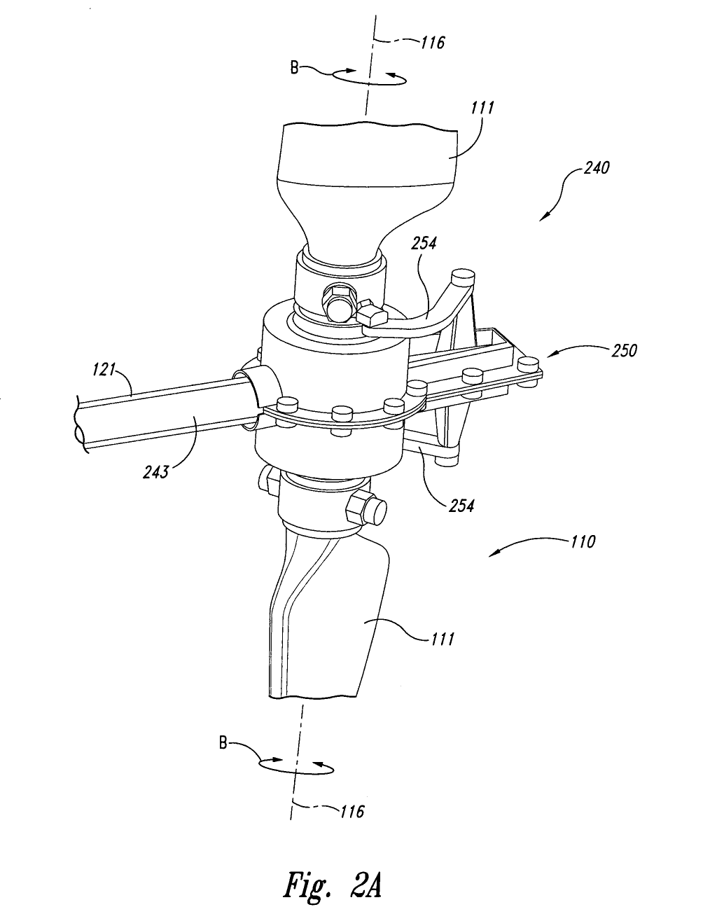

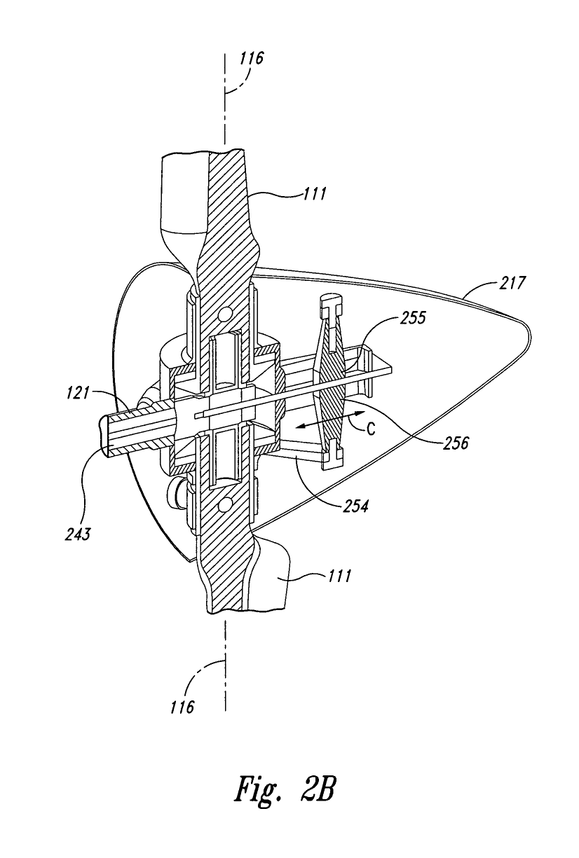

In other embodiments, the pitch of the propeller 110 can be controlled with couplings having arrangements different than that shown in FIG. 1, while also providing a contactless signal transmission link to the rotating shaft 121. For example, as shown in FIG. 2A, the first shaft 121 can house a variable pitch motor 243 connected to a variable pitch device 240 that includes a coupling 250 to rotate the propeller blades 111 as indicated by arrows B. In one aspect of this embodiment, the coupling 250 includes two arms 254, each of which rotates one of the blades 111. Further details of this arrangement are described below with reference to FIG. 2B.

FIG. 2B is a partially cut-away, partially schematic illustration of the arrangement described above with reference to FIG. 2A. As shown in FIG. 2B, the variable pitch motor 243 can be coupled to a threaded leadscrew 257 which threadably engages a threaded aperture 256 of an arm support 255. The support arm 255 is pivotably coupled to the two arms 254 shown in FIG. 2A, (one of which is visible in FIG. 2B). As the variable pitch motor 243 rotates, the threaded leadscrew 257 rotates and drives the arm support 255 axially, as indicated by arrow C. As the arm support 255 moves axially, the arms 254 pivot to rotate the propeller blades 111 in opposite directions about the second axis 116, thus changing the pitch of the propeller 110. A spinner 217 provides an aerodynamically contoured protective housing around the coupling 250.

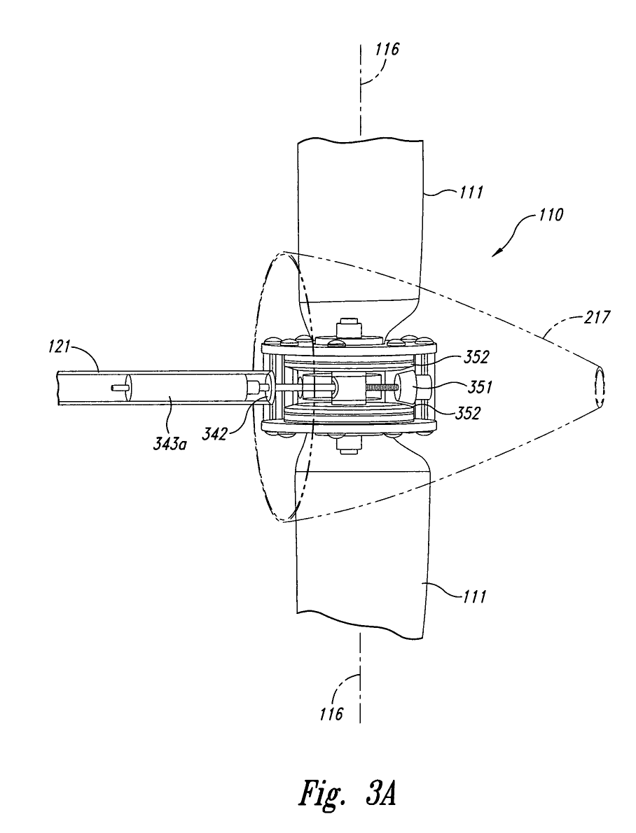

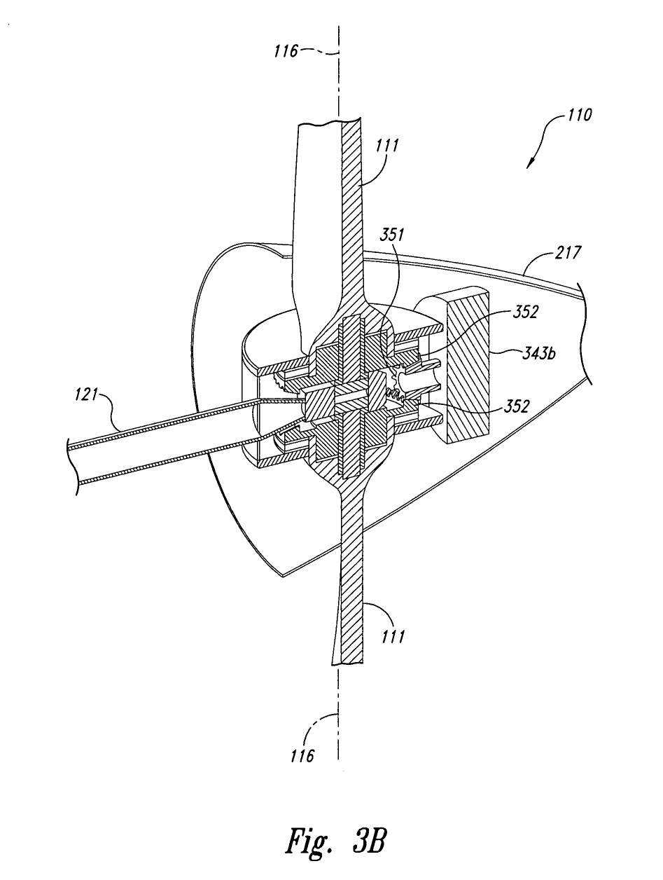

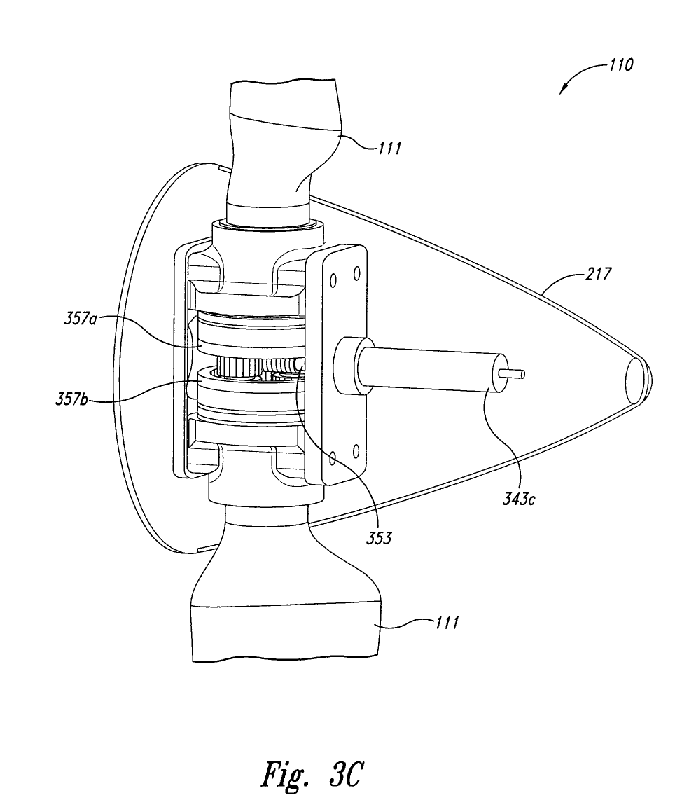

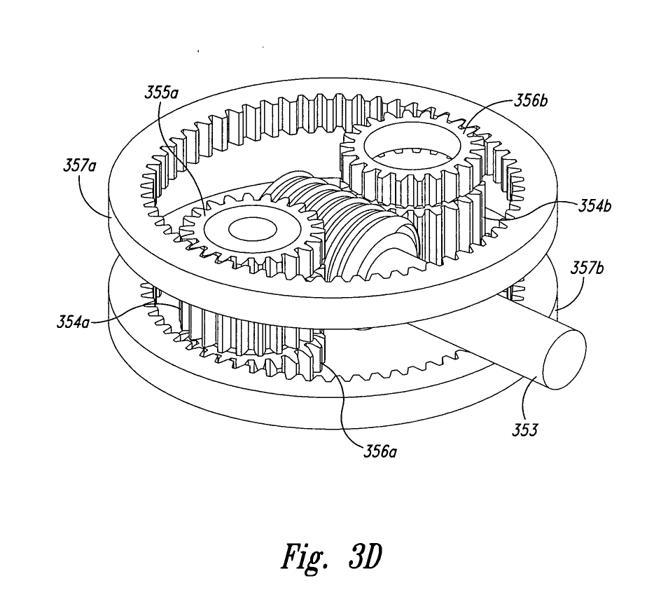

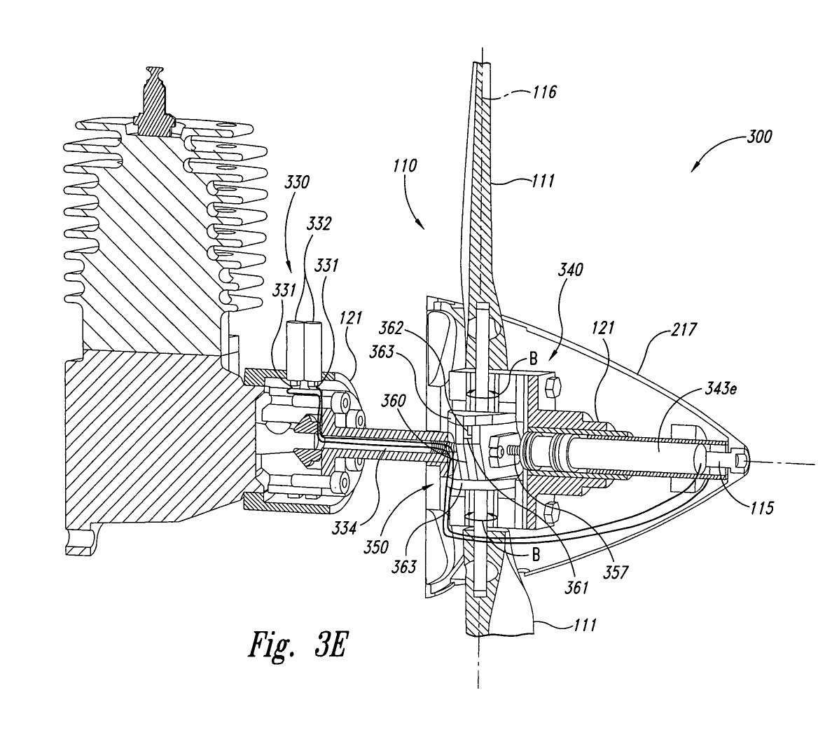

In another arrangement, shown in FIG. 3A, the first shaft 121 houses a variable pitch motor 343a generally similar to the variable pitch motor 243 described above, coupled to a variable pitch shaft 342. The variable pitch shaft 342 in turn is coupled to a bevel pinion 351. The bevel pinion 351 engages opposing bevel gears 352, each of which is coupled to one of the propeller blades 111. As the variable pitch motor 343a rotates the variable pitch shaft 342, the bevel pinion 351 rotates the propeller blades 111 in opposite directions to change the pitch of the blades 111.

In still further embodiments, the variable pitch systems described above can have other arrangements. For example, in an embodiment shown in FIG. 3B, a variable pitch motor 343b can be housed on the side of the propeller 110 opposite the first motor 120 (FIG. 1), e.g., within the spinner 217. The variable pitch motor 343b is coupled to the rotary portion 131 (FIG. 1) of the signal transmission link 130 (FIG. 1) with leads (not shown in FIG. 3B). As the variable pitch motor 343b rotates, it rotates the bevel pinion 351 and the bevel gears 352 to change the pitch of the propeller blades 111 in a manner generally similar to that described above.

FIG. 3C illustrates an arrangement in accordance with another embodiment of the invention for which a variable pitch motor 343c is also positioned within the spinner 217. The variable pitch motor 343c is coupled to a worm 353 which drives first and second internal ring gears 357a, 357b in opposite directions. Each internal ring gear 357a, 357b is attached to one of the propeller blades 111 so as to change the pitch of the propeller blades 111 as the worm 353 is rotated by the variable pitch motor 343c. Further details on the coupling between the worm 353 and the internal ring gears 357a, 357b are described below with reference to FIG. 3D.

Referring now to FIG. 3D, the worm 353 rotates a first worm gear 354a and a second worm gear 354b in opposite directions. The first worm gear 354a is attached to a first driven spur gear 355a which in turn engages the first internal ring gear 357a. The second worm gear 354b is attached to a second driven spur gear (hidden from view beneath the first internal ring gear 357a), which in turn engages the second internal ring gear 357b. The arrangement shown in FIG. 3D can also include one or more support spur gears 356 (two are shown in FIG. 3D as a first support spur gear 356a and the second support spur gear 356b). The first support spur gear 356a is coaxial with, but spins independently of, the first worm gear 354a and the first driven spur gear 355a. The second support spur gear 356b is coaxial with, but spins independently of, the second worm gear 354b and the second driven spur gear. Accordingly, the support spur gears 356 can support the worm gears 354 relative to the worm 353 and the internal ring gears 357. The arrangement shown in FIGS. 3C-3D can provide a significant gear reduction, allowing the use of a relatively small, low-torque variable pitch motor 343c. This arrangement also can fit into a compact space, reducing the moment of inertia of the variable pitch system, which in turn allows support components to be made lighter. In a further aspect of this arrangement, the torque applied by the worm 353 to the propeller blades 111 is independent of the pitch angle of the propeller blades 111, so that the variable pitch motor 343c and associated drive train need not be sized to accommodate high (but perhaps infrequently encountered) loads at the extremes of the variable pitch range of motion. In still further embodiments, the variable pitch device can have still further arrangements.

FIG. 3E illustrates a system 300 having a variable pitch device 340 configured in accordance with another embodiment of the invention. The variable pitch device 340 can include a variable pitch motor 343e carried by the first shaft 121 and housed within the spinner 217. The variable pitch motor 343e can be connected to the propeller blades 111 via a coupling 350. In one aspect of this embodiment, the coupling 350 can include a leadscrew 357 that is rotatably driven by the variable pitch motor 343e, and that engages a nut 360. The nut 360 can include a pair of slots 361 (one of which is visible in FIG. 3E), each of which receives a corresponding pivot pin 362 that is in turn connected a corresponding one of the propeller blades 111 via a blade base 363. Each of the pivot pins 362 can be eccentric relative to the second axis 116, and can be located on opposite sides of the eccentric axis 116 (e.g., the pivot pin 362 visible in FIG. 3E and coupled to the upper blade 111 can be located toward the viewer relative to the second axis 116, and the pivot pin coupled to the lower blade 111 can be located away from the viewer, beneath the plane of FIG. 3E). As the leadscrew 357 rotates, it translates the nut 360. As the nut 360 translates, it rotates the eccentric pins 362 about the second axis 116, which in turn rotates the blades 111 in opposite directions about the second axis 116, as indicated by arrow B.

The variable pitch motor 343e can be activated and controlled by a signal transmission link 330. In one embodiment, the signal transmission link 330 can include a rotary transformer generally similar to that discussed above with reference to FIG. 1. Such a signal transmission link can be implemented when the variable pitch motor 343e is an alternating current motor. In another embodiment (e.g., when the variable pitch motor 343e is a direct current motor), the signal transmission link 330 can include a set of electromechanically engaged slip rings that transmit electromagnetic signals across the boundary of the rotating first shaft 121. For example, the signal transmission link 330 can include fixed contacts 332 that make electromechanical contact with rotating slip rings 331. The slip rings 331 are connected with wires 334 to the variable pitch motor 343e. In other embodiments, the signal transmission link 330 can have other arrangements.

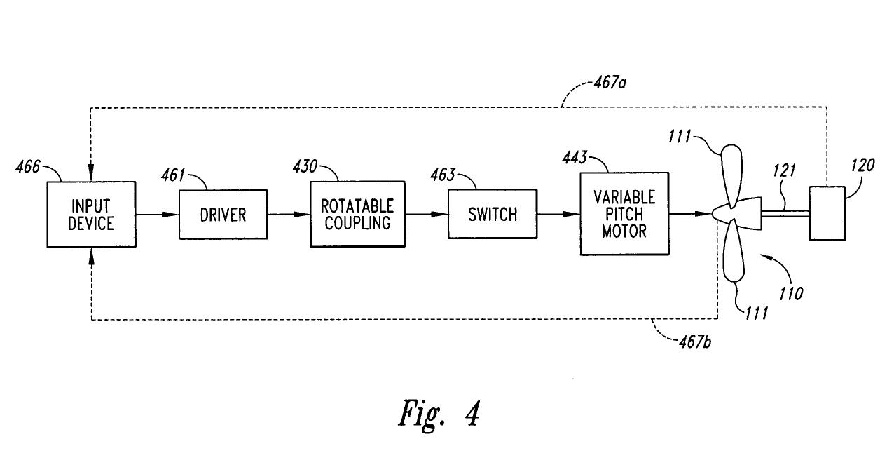

In any of the foregoing arrangements, the direction and extent of the pitch angle change provided to the propeller 110 can be controlled, for example, in an automatic or semi-automatic fashion. For example, as shown in FIG. 4, a system 460 for controlling the pitch of the propeller 110 includes an input device 466 that provides input signals to a driver 461. In one aspect of this embodiment, the input device 466 can be an operator-controlled knob or other manipulatable device. In other embodiments, the input device 466 can include computer readable media (e.g., software or hardware) that automatically generates signals supplied to the driver 461. The driver 461 can provide signals to a rotatable signal transmission link 430 that transmits the signals across the rotating boundary of the first shaft 121 (FIG. 1) in a manner generally similar to that described above. A switch 463 determines whether the signals provided by the driver 461 are to rotate the propeller blades 111 in a first direction (e.g., to increase propeller pitch angle) or a second direction (e.g., to reduce the propeller pitch angle). The signal may then be conditioned or otherwise manipulated and transmitted to the variable pitch motor 443 to change the pitch of the blades 111.

In still a further aspect of this embodiment, the system 460 can include a feedback arrangement to automatically or semi-automatically control the extent to which the pitch of the propeller 110 is changed. In a particular aspect of this embodiment, the pitch of the propeller 110 can be controlled so that the rotation speed (in revolutions per minute, or rpm) of the first motor 120 and/or the first shaft 121 is always constant. The first motor 120 typically includes a tachometer that provides an indication of this rotation speed. A signal from the tachometer can be provided to the input device 466 via a first feedback loop 467a. As a result, the pitch of the propeller 110 can be updated in a continuous or semicontinuous manner to keep the rotation speed of the first motor 120 constant. In another arrangement, the pitch angle of the blades 111 of the propeller 110 can be measured directly and this information be provided via a second feedback loop 467b in addition to or in lieu of the first feedback loop 467a. For example, the system 460 can include a magnetic or optical sensor that determines the pitch angle of the blades 111 in a contactless manner and provides a direct indication of the pitch angle via the second feedback loop 467b. In one aspect of this embodiment, the signal provided by the second feedback loop 467b can automatically adjust the signal provided by the input device 466 to keep the blades 111 at a pre-determined pitch angle. In another embodiment, the second feedback loop 467b can provide a signal to an operator who can then adjust the signal at the input device 466 to provide any desired pitch angle.

FIG. 5 is a schematic diagram of aspects of the system 460 described above with reference to FIG. 4. In one aspect of this embodiment, the driver 461 provides an electrical signal to a fixed portion 532 (e.g., a stationary winding) of the signal transmission link 430 (e.g., a rotary transformer). The electrical signals are transmitted to a rotary portion 531 (e.g., a rotating winding) of the signal transmission link 430. The signals are then provided to the switch 463 before being transmitted to the variable pitch motor 443.

In one aspect of this embodiment, the switch 463 includes a frequency discriminator 565 coupled to a direction switch 568. If the frequency of the signal transmitted to the frequency discriminator 565 is below a threshold value, the direction switch 568 assumes a first position (shown in FIG. 5) to set a first MOSFET gate 569a (with a built-in diode) at a first setting and provide signals of a first polarity to the variable pitch motor 443. If the frequency of the signal is above the threshold value, the position of the direction switch 568 changes and a second MOSFET gate 569b is activated to provide signals to the variable pitch motor 143 of an opposite polarity. Accordingly, the driver 461 can be used to change the direction of the variable pitch motor 443, based on the frequency of the signals provided to the switch 463. In other embodiments, other characteristics of the signal provided by the driver 461 can be used to vary the direction of the variable pitch motor 443. For example, the amplitude of the signal can be used to direct the variable pitch motor 443 in a first direction (e.g., if the signal is below a threshold amplitude) or a second direction (e.g., if the signal is above a threshold amplitude).

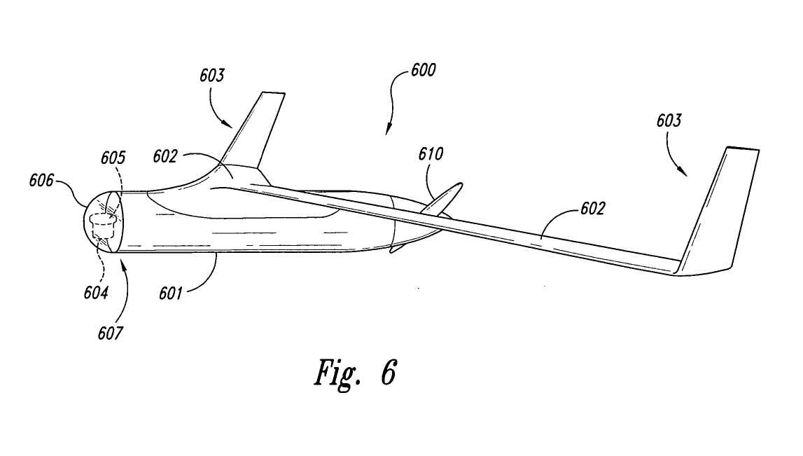

FIG. 6 is a partially schematic, isometric view of an unmanned aircraft 600 on which any of the variable pitch devices described above may be installed. In one aspect of this embodiment, the unmanned aircraft 600 can include a fuselage 601, a pair of wings 602 extending outwardly from the fuselage 601, and a propeller 610 positioned at the aft end of the fuselage 601 to propel the aircraft 600 during flight. Each wing 602 can include an upwardly extending winglet 603 for lateral stability and control. In another aspect of this embodiment, the aircraft 600 can carry a camera 604 or other payload supported by a gimbal apparatus 605. The camera 604 can be positioned behind a surveillance dome 606 in a nose portion 607 of the aircraft 600. The camera 604 can move relative to the aircraft 600 to acquire and/or track a target located on the ground, at sea, or in the air.

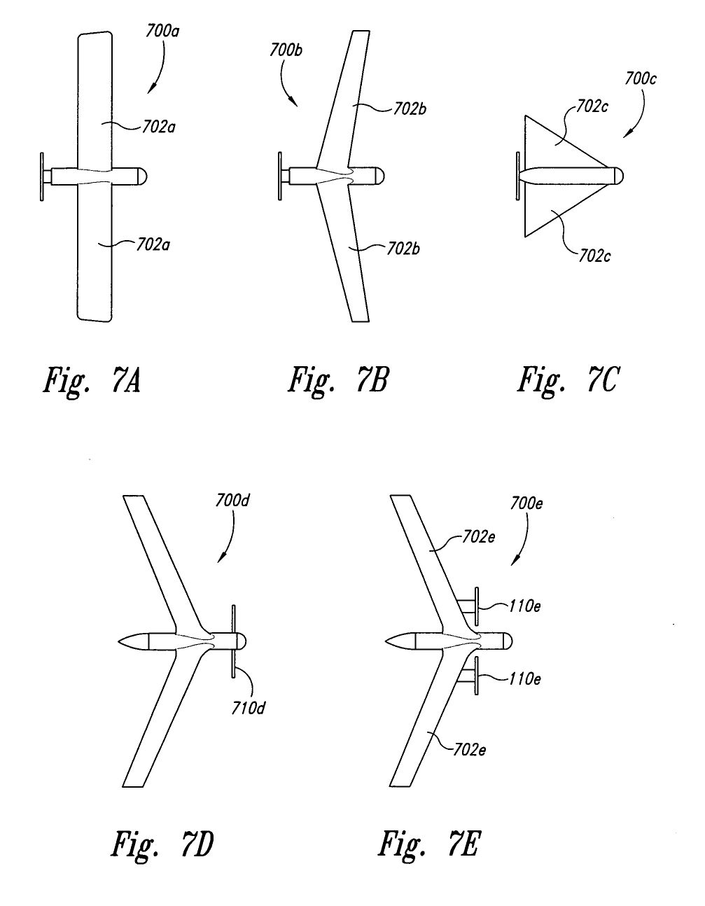

In other embodiments, any of the variable pitch devices described above can be used in conjunction with aircraft having configurations different than that shown in FIG. 6. For example, in one embodiment shown in FIG. 7A, an aircraft 700a can include generally unswept wings 702a. In another embodiment shown in FIG. 7B, an aircraft 700b can include forward swept wings 702b. In still another embodiment shown in FIG. 7C, an aircraft 700c can include delta wings 702c.

In still further embodiments, the aircraft can have propulsion systems that are different than, and/or are arranged differently than, those described above. For example, as shown in FIG. 7D, an aircraft 700d can include a nose-mounted propeller 710d. In an embodiment shown in FIG. 7E, an aircraft 700e can include twin propellers 710e, each mounted to one of the wings 702e. In still further embodiments, the aircraft can have other configurations that can benefit from one or more of the variable pitch arrangements described above.

From the foregoing, it will be appreciated that specific embodiments of the invention have been described herein for purposes of illustration, but that various modifications may be made without deviating from the invention. For example, any of the variable pitch arrangements described above can be installed on small aircraft, including UAVs, larger commercial or military aircraft, and/or non-aircraft systems. Suitable non-aircraft systems include marine propulsion systems, and stationary systems, including windmills. In other embodiments, the signal transmission links can be used to direct electromagnetic signals other than electrical signals (e.g., optical signals). Aspects of the invention described in the context of particular embodiments may be combined or eliminated in other embodiments. For example, coupling arrangements described above with reference to FIGS. 1-3A in the context of pitch actuators located external to the spinner can be applied to pitch actuators located within the spinner in additional embodiments. Further, while advantages associated with certain embodiments of the invention have been described in the context of those embodiments, other embodiments may also exhibit such advantages, and not all embodiments need necessarily exhibit such advantages to fall within the scope of the invention. Accordingly, the invention is not limited, except as by the appended claims.

1. A propeller system, comprising:
a propeller having a first blade portion and a second blade portion, the first and second blade portions being rotatable together about a first axis and being rotatable relative to each other about a second axis generally transverse to the first axis;
a shaft coupled to the propeller to rotate the propeller about the first axis;
a first signal transmission portion;
a second signal transmission portion coupled to the shaft to receive signals from the first signal transmission portion as the shaft rotates; and
an actuator carried by the shaft and coupled to the second signal transmission portion to receive the signals, the actuator being coupled to the first and second blade portions to rotate the first and second blade portions about the second axis.

2. The system of claim 1 wherein the actuator includes an electric motor coupled to the first and second blade portions with a coupling, and wherein the first and second signal transmission portions are configured to transmit electrical signals to the electric motor as the shaft rotates about the first axis.

3. The system of claim 1 wherein the first and second signal transmission portions are configured to transmit signals via a non-mechanical link.

4. The system of claim 1 wherein the first and second signal transmission portions are configured to transmit signals via an electromechanical link.

5. The system of claim 1 wherein the first signal transmission portion includes a first portion of a rotary transformer and the second signal transmission portion includes a second portion of the rotary transformer.

6. The system of claim 1, further comprising a frequency discriminator coupled between the second signal transmission portion and the actuator, the frequency discriminator being configured to direct the actuator to rotate the first and second blade portions about the second axis in a first direction when the electrical signals have a first frequency, and direct the actuator to rotate the first and second blade portions about the second axis in a second direction different than the first direction when the electrical signals have a second frequency different than the first frequency.

7. The system of claim 1, further comprising a geared coupling between the actuator and the first and second blade portions.

8. The system of claim 1 wherein the actuator includes an electric pitch control motor, and wherein the first and second signal transmission portions are configured to transmit electrical signals to the electric motor as the shaft rotates about the first axis, and wherein the system further comprises:
a propulsion motor coupled to the shaft to rotate the propeller about the first axis, the propeller being positioned between the pitch control motor and the propulsion motor; and
a coupling connected between the pitch control motor and the first and second blade portions, the coupling including:
a leadscrew rotatably driven by the pitch control motor; and
a nut axially driven by the leadscrew, the nut being operatively coupled to the first and second blade portions to rotate the blade portions in opposite directions as the nut translates axially.

9. An apparatus for controlling the pitch of a propeller, comprising:
a pitch control actuator configured to be carried by a propeller shaft;
a first signal transmission portion;
a second signal transmission portion coupled to the pitch control actuator to receive electromagnetic signals from the first signal transmission portion as the second signal transmission portion and the pitch control actuator rotate relative to the first signal transmission portion; and
a coupling connected to the pitch control actuator, the coupling being configured to connect to at least one propeller blade to change a pitch angle of the blade when the pitch control actuator is activated.

10. The apparatus of claim 9 wherein the actuator includes an electric motor, and wherein the first and second signal transmission portions are configured to transmit electrical signals to the electric motor as the electric motor rotates relative to the first signal transmission portion.

11. The apparatus of claim 9 wherein the first signal transmission portion includes a first portion of a rotary transformer and the second signal transmission portion includes a second portion of the rotary transformer.

12. The apparatus of claim 9 wherein the first and second signal transmission portions include a slip ring arrangement configured to transmit electrical signals to the pitch control actuator.

13. The apparatus of claim 9 wherein the coupling includes:
a leadscrew rotatably driven by the pitch control actuator; and
a nut axially driven by the leadscrew, the nut being operatively couplable to the at least one propeller blade to rotate the at least one propeller blade as the nut translates axially.

14. A propeller system, comprising:
a rotatable propeller shaft carrying at least one propeller blade;
means for controlling a pitch of the at least one propeller blade, the means for controlling being carried by the propeller shaft; and
signal transmission means for directing the means for controlling, the signal transmission means being configured to direct electromagnetic signals to the means for controlling, with a first part of the signal transmission means being configured not to rotate with the rotatable propeller shaft and a second part being configured to rotate with the rotatable propeller shaft.

15. The system of claim 14 wherein the signal transmission means includes an electrical slip ring arrangement.

16. The system of claim 14 wherein the means for controlling includes an electrically powered rotary motor.

17. The system of claim 14 wherein the means for controlling includes an electrically powered motor and a mechanical coupling configured to be coupled between the motor and the at least one propeller blade.

18. An unmanned air vehicle, comprising:
an airframe configured for unmanned flight;
a propeller coupled to the airframe, the propeller having a first blade portion and a second blade portion, the first and second blade portions being rotatable together about a first axis and being rotatable relative to each other about a second axis generally transverse to the first axis;
a shaft coupled to the propeller to rotate the propeller about the first axis;
a propulsion motor coupled to the shaft to rotate the shaft about the first axis;
a first signal transmission portion;
a second signal transmission portion coupled to the shaft to receive signals from the first signal transmission portion as the shaft rotates; and
an actuator carried by the shaft and coupled to the second signal transmission portion to receive the signals, the actuator being coupled to the first and second blade portions to rotate the first and second blade portions about the second axis.

19. The air vehicle of claim 18 wherein the first and second transmission portions are configured to transmit electromagnetic signals to the actuator as the shaft rotates.

20. The air vehicle of claim 18 wherein the propeller is positioned between the actuator and the propulsion motor.

21. The air vehicle of claim 18, further comprising a coupling connected between the actuator and the first and second blade portions, the coupling including:
a leadscrew rotatably driven by the actuator; and
a nut axially driven by the leadscrew, the nut being operatively coupled to the first and second blade portions to rotate the blade portions in opposite directions as the nut translates axially.

22. A method for controlling the pitch of aircraft propeller blades, comprising:
transmitting an electromagnetic signal to an actuator carried by a rotating propeller shaft; and
activating the actuator via the electromagnetic signal so as to change the pitch angle of propeller blades carried by the rotating propeller shaft.

23. The method of claim 22, wherein changing the pitch angle includes transmitting a mechanical signal from the actuator to the propeller blades via a mechanical coupling carried by the propeller shaft.

24. The method of claim 22 wherein transmitting an electromagnetic signal includes transmitting an electrical signal to an electric motor.

25. The method of claim 22 wherein transmitting an electromagnetic signal includes transmitting an electrical signal to an electric motor via a rotary transformer.

26. The method of claim 22, further comprising:
directing the actuator to change the pitch angle of the propeller blades in a first direction by transmitting an electrical signal at a first frequency; and
directing the actuator to change the pitch angle of the propeller blades in a second direction opposite the first direction by transmitting an electrical signal at a second frequency different than the first frequency.

27. The method of claim 22 wherein the propeller shaft is driven by a propulsion motor, and wherein activating the actuator includes activating an actuator positioned on an opposite side of the propeller as the propulsion motor.

28. The method of claim 22 wherein the propeller shaft is driven by a propulsion motor, and wherein activating the actuator includes activating an actuator positioned on the same side of the propeller as the propulsion motor.

29. The method of claim 22 wherein changing the pitch angle of propeller blades carried by the propeller shaft includes:
receiving pins carried by the propeller blades in slots of a nut, the pins being eccentric relative to a pitch axis of the blades; and
rotating the propeller blades in opposite directions about the pitch axis by:
rotating a leadscrew about a leadscrew axis, the leadscrew being engaged by the nut; and
translating the nut along the leadscrew axis.
